(19) United States
(12) Patent Application Publication
(10) Pub. No.: US 2005/0076319 A1
(43) Pub. Date: Apr. 7, 2005

(54) Pin assignment in block-based integrated circuit design methodologies

(76) Inventors: Shau-Lim Stan Chow, Los Altos, CA (US); Kwok Ming Yue, Fremont, CA (US)

Correspondence Address: Anthony T. Cascio;Suite 314, 423 Broadway Ave., Millbrae, CA, 94030-1905, US

(21) Appl. No.: 10/678,466

(22) Filed: Oct. 3, 2003

(51) Int. Cl. G06F 9/45; G06F 17/50

(52) U.S. Cl. 716/10; 716/13

(57) ABSTRACT

In pin assignment for blocks in a netlist, each one of a plurality of pins are first assigned to a respective one of a plurality of first locations along a periphery a block in accordance with top-down criteria and components are then placed within in the block in relative proximity to the pins with which the components connect. Each of the pins may then be moved to a respective second location within the block proximal the components to which such pins connect in accordance with bottom-up criteria. The components may then have their placement refined in accordance to their relative position to the pins connecting to such components at the second location.

### BACKGROUND OF THE INVENTION

The present invention relates generally to block-based integrated circuit design methodologies and more particularly to a novel method for pin assignment in the blocks used in such methodologies.

In a conventional block-based design methodology, the design of an integrated circuit is defined by hierarchical netlist. The netlist contains information of the nets and instances of all components seen at each hierarchal level. At any one level, the components may consist of standard cells, hard and soft macros, functional blocks, and other known types of design blocks. The netlist is hierarchical in that a block component at any level of the netlist may in turn be comprised of one or more blocks, standard cells and nets at the next lower level.

Typically, at the top level of the netlist, several blocks may be placed to define the overall layout and function of the integrated circuit. Completing the top level of the netlist, standard cells may also be placed between the blocks and the wiring of the net routed to interconnect the blocks and standard cells to implement the function.

This process continues through each subsequent lower level of the hierarchy until the lowest level is reached at which each block seen at the lowest level is comprised of standard cells. Thus, at any currently seen level in the hierarchy, the blocks visible at the current level are placed with the standard cells also seen at such level and the wiring of the current level being routed.

Also at each level of the hierarchy, block pins are assigned to a respective physical location, typically along its edge or periphery, within each of the blocks seen at such level. These pins connect the wiring internal of each block to the wiring external of the block at the current level of the hierarchy. In the prior art, the assigning of these pins to a physical location in each block is performed by either a top-down approach or a bottom-up approach.

Generally, when the pins are assigned in the top-down approach, the nets and the blocks at the current level are seen, but not the components within the blocks. Conversely, when pins are assigned in the bottom-up approach, the components within the block are seen, but not the nets or other blocks that connect to the block. As compared to each other, the use of one of these approaches to assign block pins may confer specific benefits and advantages over the use of the other approach when criteria such as block placement, the placement of components within blocks and routing between and within blocks are considered. However, each of these approaches has its respective disadvantages and limitations in the overall integrated circuit design.

In the top-down approach, the block pins are assigned to their respective locations within a block after the integrated circuit design has been partitioned into the block hierarchy. More particularly, after the blocks have been placed at the current level of the hierarchy, the pins for each block are assigned to a physical location substantially adjacent its periphery or sides. The location to which any one pin is assigned in any one block is determined, for example, in accordance with the placement of such block with respect to the other blocks at the current level and the connectivity constraints between such pin and one or more other pins of the other blocks to which it will connect. Accordingly, a primary goal of the top-down approach is to assign each pin to an optimal physical location within its block in accordance with top-level routability and timing constraints of the integrated circuit design.

The blocks used in a typical netlist include hard macros, i.e., blocks that have been physically implemented in a library, and soft macros, i.e., blocks that have not yet been implemented, may be intermixed with each other. In the top-down approach, the hard and soft macros, as well as the other components, are placed after partitioning, and timing and physical modeling is performed. After block placement, the top-down pin assignment commences.

In each of the hard macros, the physical locations to which their respective pins are assigned have already been well defined in the library. The physical location each of the hard macro block pins will have vis-a-vis pins of other components will then be determined solely by the placement of the hard macro itself, and its pins will be not subject to further assignment to other locations. Accordingly, only the soft macro block pins may be assigned after block placement.

After block placement, it may be seen that a preferred placement for several block pins within a soft macro block may be along one of its edges when top-level routing and timing constraints with respect to other blocks is considered. However, this edge may not be able to accommodate all of these pins, either because of lack of available locations or because routing congestion would otherwise result. Therefore, some of these pins are then disadvantageously assigned to less preferential locations along other edges of the block. Although routing congestion may be eased, timing between blocks may be degraded.

Since at the time of pin assignment components within the block are not seen, the assigned locations may further disadvantageously degrade routing or timing to the components within the block to which these pins connect. For example, wire lengths to such block internal components may become excessive or internal routing may become congested.

In the bottom-up approach, each of the block level pins is pre-assigned to its respective physical location based primarily on data flow and timing within the block. For example, these pins may be assigned to locations within the block in accordance with the placement of the standard cells and lower level blocks inside the block. Preferably, each block pin is assigned to an edge of the block closest to the component within the same block to which the pin is connected to minimize wire length. Thus, the bottom-up approach is advantageous with respect to wire length inside the block when compared to the top-down approach as described above.

However, since the physical location for each of the block pins is fixed within each block, the location that each of these pins after block placement is solely a function of the placement of its respective block. Although within each block, wire lengths, data flow and timing may be acceptable, top level routability and timing constraints may be disadvantageously degraded.

In either of the pin assignment approaches described above, the block pins have been permanently assigned to locations adjacent the periphery of the block such that each of these pins can be accessed externally of the block with wires in the same hierarchical level of the netlist. Irrespective of the approach used, restricting pin locations to the periphery of a block disadvantageously excludes all other possible locations within the block that the pins may be placed to optimize placement with respect to both the components they connect to within a block and the pins of other blocks and cells in the current level of the netlist.

However, if block pins could be placed at any location internally in the block, and not along its periphery, these pins typically may only be accessed through a via dropped from a next higher level in the netlist. Although vias are well known in fabrication processes, some design processes do not allow a via to be dropped from a higher level to a location within a block since violation of a prohibition against stacking vias may result.

In FIG. 1 (Prior Art), there is shown an exemplary block 1 useful to explain the aforementioned prohibition against stacking of vias. The exemplary block 1 may include, inter alia, a cell 2, a first metal layer (M1) 3₁, a second metal layer (M2) 3₂, and a top third metal layer (M3) 3₃. The cell 2 may include a cell pin 4 in the M1 layer 3₁. The M3 layer 3₃, being the top layer of the block 1, includes all the block pins, such block pins 5 exemplarily shown along an edge 6 of the block 1. Connection is made to the block 1 exemplarily by wires 7 connecting to the block pins 5. The wires 7 are part of a net in the same level of a netlist in which the block 1 resides.

Typically, the block 1 would be internally routed such that the cell pin 4 would connect to one of the block pins 5. However, the placement of a block pin to connect to the cell pin 4 may optimally be at some internal location within the block 1 and not along its edge 6 or any other edge thereof. For example, this optimal internal location may be shown at a block pin 5_{A} provided to connect to the cell pin 4. Routing of the block 1 between the cell pin 4 and the block pin 5_{A} may exemplarily result in a first via 8₁ dropped from the M3 layer 3₃ at the location of the block pin 5_{A} to the M2 layer 3₂ and a second via 8₂ dropped from the M2 layer 3₂ to the cell pin 4. The first via 8₁ and the second via 8₂ are vertically offset from each other such that a wire 9 in the M2 layer 3₂ is provided to make a connection between them.

The block pin 5_{A}, since it is at a location internally within the block 1 and not along its edge 6, is no longer accessible to a router operating in the hierarchical level of the block 1 and, therefore, cannot be reached the current level of the net that includes the wires 7. To connect to the block pin 5_{A}, a third via 8₃ would need to be dropped from the next higher level of the netlist. A wire (not shown) in the next higher level would need to be routed to the via 83 to connect to the block pin 5_{A}.

However, a router at the next higher level would only see the block 1 and the block pins 5, including block pin 5_{A}, and not the internal routing within the block 1. Should this router drop the via 8₃, a violation against the prohibition against stacking vias would occur, as best seen in FIG. 1. It is for this reason that some of the known design processes do not allow vias to be dropped from a higher hierarchical level to a location within a block. Accordingly, there exists a need to provide a process and method allowing placement of block pins internally within a block and further allowing dropping of vias to these internally located pins.

### SUMMARY OF THE INVENTION

It is a primary object of the present invention to provide a pin assignment method that overcomes one or more disadvantages and limitations of the prior art hereinabove enumerated.

It is an important object of the present invention to provide a pin assignment method that enables block pins to be assigned to locations internally within a block after placement of the block to place such pins with respect to connectivity to pins of other blocks at the current level substantially concurrently with respect to connectivity to components within the block.

It is a further object of the present invention to provide in a pin assignment a method that allows placement of block pins internally within a block and further allowing dropping of vias to these internally located pins.

According to the present invention, each one of a plurality of pins are first assigned to a respective one of a plurality of first locations along a periphery of a block and components are then placed within in the block in relative proximity to the pins with which the components connect. Each of the pins may then be moved to a respective second internal location proximal the components to which such pins connect. The components may then have their placement refined in accordance to their relative position to the pins connecting to such components at the second location.

A feature in one particular embodiment of the present invention is that the final location of the pins is determined first preferentially with respect to interconnectivity between blocks and then replaced preferentially in accordance with respect to connectivity within the block. This feature advantageously optimizes connectivity constraints between blocks as with the top-down approach concurrently with optimizing connectivity constraints within each block as with the bottom-up approach. By combining the advantages of both approaches in a new and unique process, their respective disadvantages are mitigated.

For example, when the pins are first assigned to the block periphery, the top-level connectivity constraints may be taken into consideration for the placement of the pins similarly to the top-down approach. The components to which these pins connect are placed within the block, taking into consideration connectivity constraints between the components and the pins to which the components will connect. After the components are placed, any of the pins may be moved away from the block periphery to an internal location proximal the component to which it connects. The shape of the pins may also, in one particular embodiment, be abstracted to a distributed shape to enhance top-level routability. Internal block connectivity concerns, similar to the bottom-up approach, may be used when moving the pins. Finally, with the pins having been moved, the positioning of the components in the block may be refined, again in accordance with connectivity constraints between components and the pins connecting thereto. Thus, combining the advantages of a top-down and bottom-up approach to pin assignment results in a preferential placement of pins for connectivity to other blocks and cells in the current level of the netlist concurrently with preferential placement of pins for connectivity to components in the block.

Another feature in another embodiment of the present invention is that block pins may be placed as virtual pins to reserve spaces for vias. Such virtual pins may be formed in a temporarily created block top layer. The block is routed with connections being made to the virtual pins. The temporary top layer and virtual pins are removed during block abstraction such that pins remaining in the true top layer of the block can be accessed by vias from then next higher level in the netlist. This feature advantageously obviates violation of the prohibition against via stacking by ensuring that a via dropped from a hierarchical level above the block will not stack above a via routed within the block.

These and other objects, advantages and features of the present invention will ecome readily apparent to those skilled in the art from a study of the following escription of the Exemplary Preferred Embodiments when read in conjunction with the attached Drawing and appended Claims.

### BRIEF DESCRIPTION OF THE DRAWING

FIG. 1 (Prior Art) is an exploded perspective view of an exemplary block showing a prohibited stacking of vias;

FIG. 2 is a flowchart of an exemplary method practiced in accordance with the principles of the present invention;

FIGS. 3A-3D are illustrative of pin assignment and object placement at various steps of the method of FIG. 2;

FIG. 4 is a flowchart of exemplary embodiments of the assigning step of FIG. 2;

FIG. 5 is a block diagram of an integrated circuit showing three blocks illustrative of various embodiments of the aligning step of FIG. 4;

FIG. 6 is a flowchart of on embodiment of the moving step of FIG. 2;

FIGS. 7A-7B are exploded perspective views of an exemplary block illustrative of a method avoiding the stacking of vias seen in FIG. 1; and

FIG. 8 is a flowchart of an exemplary method useful to assign pins to avoid stacking of vias.

### DESCRIPTION OF THE EXEMPLARY PREFERRED EMBODIMENTS

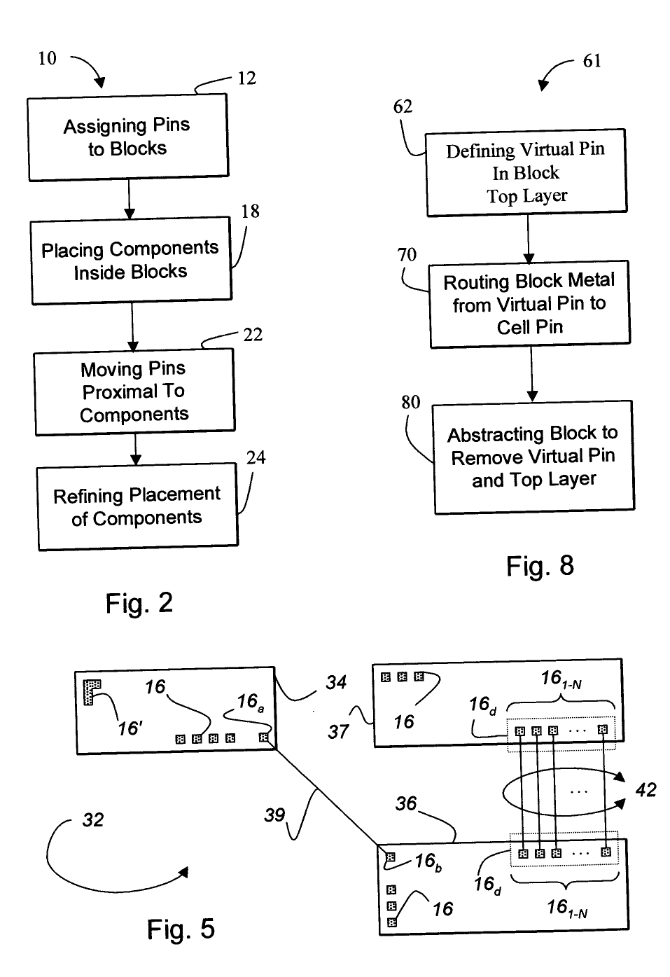

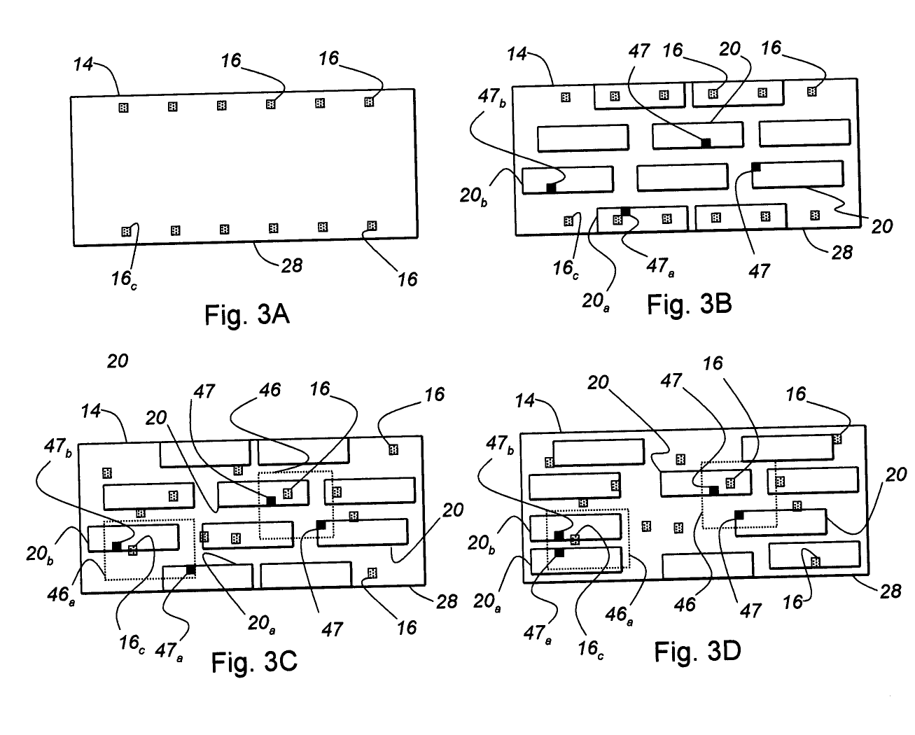

Referring now to FIG. 2, there is shown a flowchart 10 illustrative of an exemplary method of block pin assignment in a block of a netlist for an integrated circuit design. In its broadest aspects, the method of the present invention includes the step 12 of assigning within a block 14 a plurality of block pins 16 to a respective one of a plurality of first locations, as exemplarily seen in FIG. 3A, the step 18 of placing in the block 14 a plurality of components 20, wherein each of the components 20 is placed in relative proximity to the pins 16 respectively connecting to each of the components 20, as exemplarily seen in FIG. 3B, the step 22 of moving selected ones of the pins 16 to a respective one of second locations proximal the components 20 connecting to the selected ones of the pins 16, as exemplarily seen in FIG. 3C, and the step 24 of refining placement of the components 20 with respect to the selected ones of the pins 16 at the second location connecting thereto, as exemplarily seen in FIG. 3D.

In the above described method of flowchart 10, the components 20 in the block 14 may be any of the components as defined above as exemplarily including standard cells, hard and soft macros and sub-blocks in the netlist. It is also to be understood that the first locations to which the block pins 16 are assigned in accordance with the assigning step 12 need not be limited to the positions, as seen in FIG. 3A, but may be any position within the block 14.

Typically, the present invention is performed after the floor planning steps of a block-based design process. For example, in known block-based design processes data concerning the integrated circuit, such as netlist, timing constraints, libraries and physical data, is loaded such that the data can be used by the software implementing such process.

The software process then partitions the circuit being designed. After partitioning, initial timing and physical modeling followed by block placement are performed.

When the blocks are placed, the number of pins in each of the blocks is known, but not their location. Initially all such pins within a block may be placed at its center or at any other convenient location. It is at this point in the design process that the assigning step 12 of the present invention may be commenced to assign the pins to locations within each of the blocks.

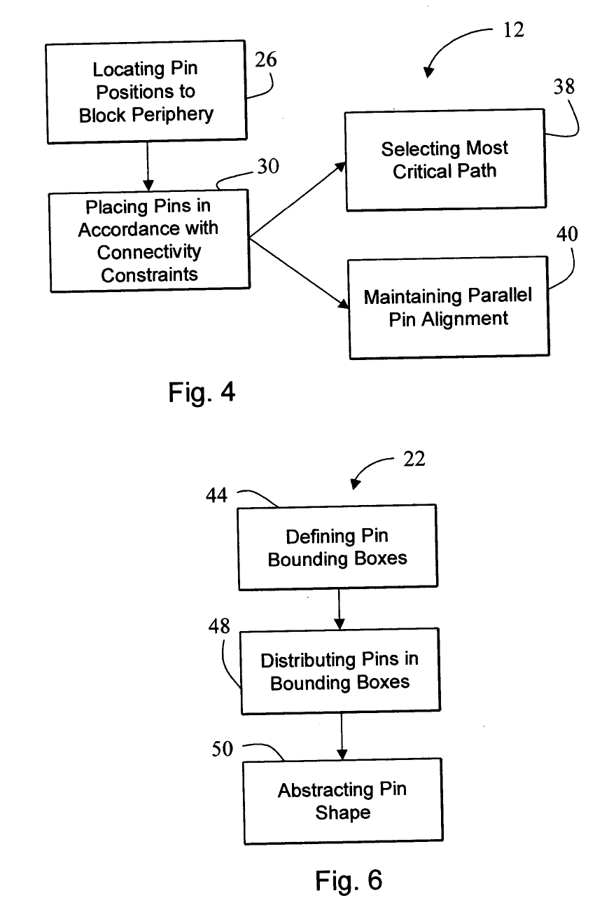

With further reference to FIG. 4, the assigning step 12 may, in a preferred embodiment of the present invention, specifically include the step 26 of locating each of the first locations for each respective one of the pins 16 proximal a periphery 28 of the block 14, and the step 30 of placing each one of the pins 16 into a respective one of the first locations, as seen in FIG. 3A. The pins 16 are placed into their respective first locations in accordance with top level or top-down connectivity constraints to other such pins contained in other such blocks at a current hierarchical level of the integrated circuit.

To place the pins 16, in accordance with the placing step 30, known heuristic or global routing algorithms may be used. Typically, a heuristic based on the shortest distance of pin-to-pin connection may be readily performed and may yield reasonably acceptable results. However, if there are blockages or routing congestion, the heuristic used by itself may yield a sub-optimal result. A global router that detects blockages and congestion may avoid such blockages and congestion while routing pin-to-pin connections, resulting in improved placing of the pins 16 to their respective first locations.

Specific examples of the placing step 30 may be seen with further reference to FIG. 5, wherein there is shown an exemplary integrated circuit design 32, the netlist for which has a first block 34 and a second block 36. Each of the first block 34 and the second block 36 have a plurality of the block pins 16. The netlist for the design 32 may also include a third block 37 having block pins 16.

In one example, the placing step 30 may further include the step 38 of selecting a most critical path 39 to assign at least one pin 16ₐ in the first block 34 and at least one corresponding pin 16b in the second block 36. The most critical path 39 may typically be chosen by first ranking the criticality of all paths based on timing constraints. For example, the path having the worst timing between the block 34 and the block 36 may be chosen as the most critical path 39. Since the path 39 has the worst ranking of criticality it should preferably be selected to be the shortest path between the block 34 and the block 36, as best seen in FIG. 5. Once the most critical path 39 is selected, the pin 16ₐ in the first block 34 and the corresponding pin 16_{b} in the second block 36 may be assigned to their respective locations on this path 39.

In the exemplary design 32, the placing step 30 may first be performed on the pin 16ₐ in the first block 34 to take it from the center of the block 34 (or any other initial position the pin occupies prior to performing the assigning step 12 as described above) to its respective first location, which is selected to be closest to the second block 36. Similarly, the placing step 30 may then be subsequently performed on the corresponding pin 16_{b} in the second block 36 to place it from the center of the block 36 to its respective first location, which is selected to be closest to the first block 34 to result in the most critical path 39 to be the shortest path.

Placement for the remaining pins 16 in each of the first block 34 and the second block 36 may then proceed based, similarly as described immediately above, for each subsequent path in decreasing order of their criticality ranking. For example, the second most critical path would be identified and its respective pins assigned, and so forth until the least critical path is reached and its pins assigned.

As described immediately above, the placing step 30 is performed first with respect to pin 16ₐ and subsequently with respect to pin 16_{b}. In general, the broadest aspects of the method of the present invention as described in reference to FIG. 2 may be preferably performed serially with respect to each block at each level in the netlist for a particular design. For example, in a netlist for the simplified integrated circuit design 32 of FIG. 5, each of the steps described above in the flowchart 10 of FIG. 2 may first be performed with respect to the pins 16 of the first block 34, then continue with the pins 16 of the second block 36 and, finally, continue with the pins 16 of the third block 37.

Another example of the placing step 30 of FIG. 4 may also be seen in FIG. 5. The placing step 30 may further include the step 40 of maintaining parallel alignment of selected ones of the pins 16_{1-N} in the second block 36 to corresponding selected ones of the pins 16_{1-N} in the third block 37, to provide pin connections at each of these blocks for an N-bit wide bus 42. Specifically, the pins 16_{1-N} in each of the second block 36 and the third block 37 may be represented by a single distributed pin 16_{d} in each of these blocks. In general, once a bus is assigned, the selected spacing of the bus pins between blocks is maintained by use of the distributed pin, similarly as described with respect to pin 16_{d}.

With reference to FIG. 6, in a further embodiment of the present invention, the moving step 22 may include the step 44 of defining pin bounding boxes 46 (FIG. 3C) within the blocks 14. The bounding boxes 46 are defined in the netlist used in the design process and each bounding box 46 contains a plurality of component pins 47 of one or more of the components 20. A respective one of the block pins 16 will connect to the component pins 47 in each bounding box 46. Accordingly, the moving step 22 may further include the step 46 of distributing each respective one of the block pins 16 into the bounding box 46 containing the component pins 47 to which it will connect.

For example, as best seen in FIGS. 3C-3D, a bounding box 46ₐ may be defined to contain a component pin 47ₐ of a component 20ₐ and a component pin 47_{b} of a component 20_{b}. A block pin 16_{c} that connects to the component pin 47ₐ and the component pin 47_{b} may be moved from its first location seen in FIGS. 3A-3B to its second location within the bounding box 46ₐ seen in FIG. 3C.

In this specific example, the block pin 16_{c} had first been placed in its first location n FIG. 3A in accordance with the pin placing step 30 and top-down connectivity constraints. Next, the component 20ₐ and the component 20_{b} are placed in the block 14 in accordance with the block placing step 18. The pin 16_{c} is then moved into the bounding box 46ₐ to its second location taking into consideration bottom-up criteria such as the connectivity of the block pin 16_{c} to the component pin 47ₐ of the component 20ₐ and the component pin 47_{b} of the component 20_{b} to which the block pin 16_{c} connects, as seen in FIG. 3C. Thereafter, the placement of the component 20ₐ may be refined, as seen in FIG. 3D, such that the pin 47ₐ is preferentially placed with respect to the pin 16_{c}. Similarly, each other of the components 20 in the block 14 may also have their positions refined with respect to the pins 16 connecting thereto.

The above described step 48 of distributing each respective one of the block pins 16 into its bounding box 46 beneficially enhances routability between a block pin 16 and its associated component pins 47 and eases routing congestion with the block 14. For example, each of the bounding boxes 46 generally defines an area containing the component pins 47 to which the respective block pin 16 will connect. When each of the block pins 16 are distributed into their respective bounding box 46, the component pins therein become grouped with the block pin 16 with which they connect. It is thus seen that any block pin 16 within its bounding box 46 has been placed within relative proximity to the components 20 to which it connects. The refining step 24 enhances this grouping by adjusting the position of the components 20 such that their component pins 47 are preferentially positioned with respect to the block pin 16 in the bounding box.

In any event, the distributing of the pins 16 must be done within the constraints of top-level routability. The moving step 22, and in particular the distributing step 48, together with the refining step 24, may be reiterated as often as necessary to provide an optimal placement for the pins 16.

The moving step 22 may further include the step 50 of abstracting a shape of each of the pins 16 from a small shape to a distributed shape, as best seen at 16 in FIG. 5, to enhance routability at a top hierarchical level of the integrated circuit. The distributed shape gives a router a larger target area to connect to a pin 16, especially in the event of congestion about a particular pin 16.

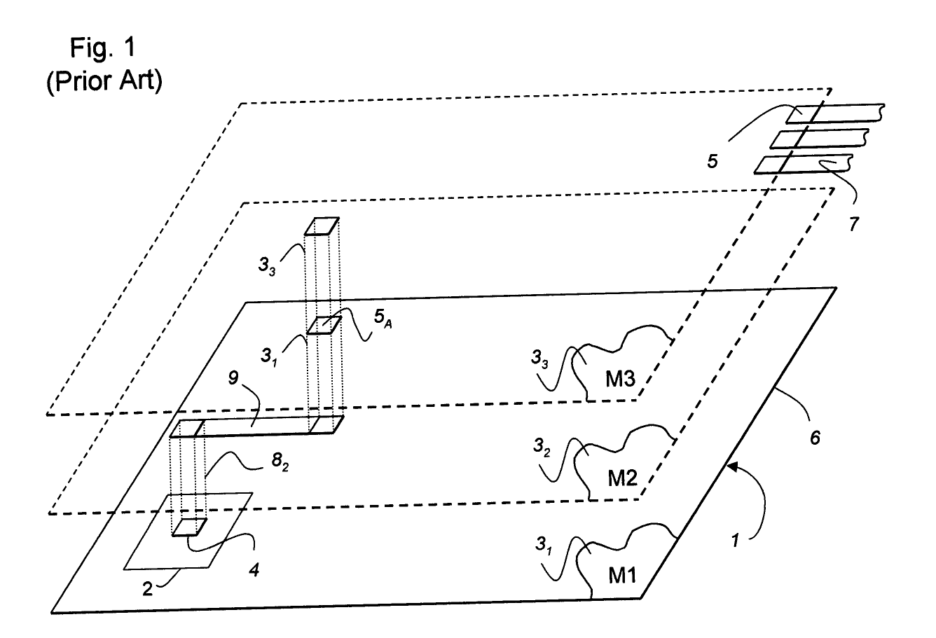

Generally, in block-based design processes, each block will have multiple layers of metal and the pin layer is chosen based on the number of layers used in a block. Typically, the top layer is used for the block pins, as described above with reference to FIG. 1.

The width of the block pins 16 is coextensive with the minimum layer width, which is determined by the specific fabrication process to be used. If any of the pins 16 belong to a net that requires a larger width, such as for high current wires, such pins 16 assume the larger net width. Similarly, a minimum layer spacing rule for wires with the net is used to determine the spacing between neighboring pins 16, however, the net spacing rule may take precedence. In accordance with the net spacing rule, extra spacing may be reserved between wires of a net to minimize capacitive coupling between wires. The pins 16 in these nets subject to the rule assume the same wire spacing.

Furthermore, power or ground nets may be used to shield a signal net from potential noise induced by neighboring signal nets. The pins 16 in the one of the signal nets is accordingly separated by the power or ground net from the pins in the neighboring signal net.

As described above, the pins 16 after the performing the moving step 22 may be at locations anywhere within the block 14, subject to the criteria as described above. As described above with reference to FIG. 1, a pin that is within a block and not at its edge may be accessible only from a via dropped from the next higher level of the netlist. To avoid violating the prohibition against stacking of vias which may occur from dropping this via, a method will be hereinafter described that assigns virtual pins to respective locations within the block to reserve sites at which a router can drop a via from the next higher level in the netlist to the block without violating this prohibition.

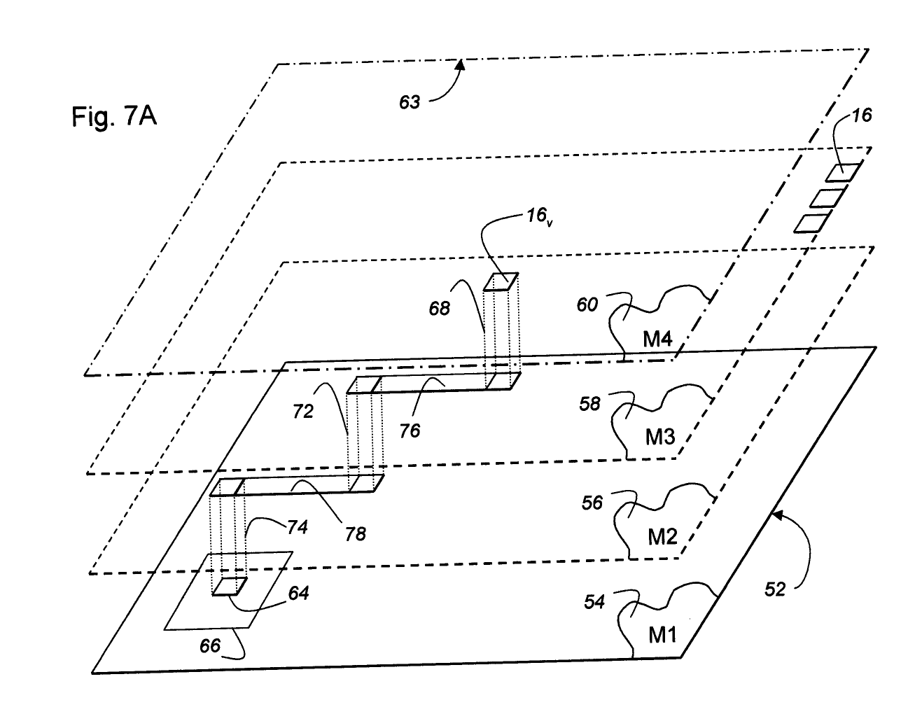

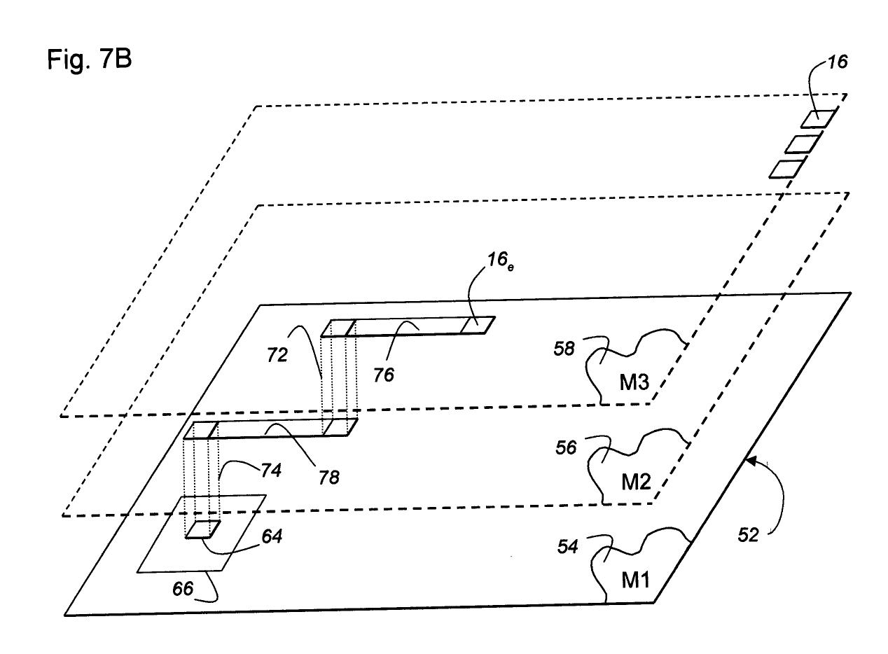

Prior to setting forth a description of this method, reference is made to FIGS. 7A-7B wherein there is shown an exemplary block 52 upon which the hereinafter described steps of the method act upon. The block 52 may include a first metal layer (M1) 54, a second metal layer (M2) 56 and a third metal layer (M3) 58, wherein the first through third metal layers M1-M3 are used for routing inside the block 52. A top metal layer (M4) 60 is temporarily created. The significance of the temporary M4 layer 60 will become apparent from the following description.

With further reference to FIG. 8, there is shown a flowchart 61 of an exemplary method to avoid stacking of vias includes the step 62 of defining a virtual pin 16ᵥ, as best seen in FIG. 7A, in the temporary M4 layer 60. The virtual pin 16ᵥ may further be contained within a blockage 63 also defined in the M4 layer 60 to prevent a router from using any of the M4 layer 60 inside the block 52. The blockage 63 may be coextensive with the M4 layer 60, as seen in FIG. 7A.

After the virtual pin 16ᵥ is defined, the method of FIG. 8 proceeds to a routing step 70 that is performed to connect, for example, the virtual pin 16ᵥ to a cell pin 64 of a cell 66 within the block 52. An exemplary connection path as a result of the routing step 70 may include a first via 68 dropped from the virtual pin 16ᵥ in the M4 layer 60, a second via 72 dropped from the M3 layer 58 to the M2 layer 56, and a third via 74 dropped from the M2 layer 56 to the cell pin 64 in the M1 layer 54. Completing the exemplary connection, a wire 76 in the M3 layer 58 connects the first via 68 and the second via 72, and a wire 78 in the M2 layer connects the second via 72 and the third via 74 to complete the routing to the cell pin 64.

After the block 52 is routed, an abstracting step 80 is performed wherein the block 52 is abstracted to form geometrical pins and blockages for top level routing. In the abstraction, the virtual pin 16v, the blockage 63, and any other pins and blockages in the M4 layer 60 are removed. Similarly, the first via 68 as well as any other vias between the M4 layer 60 and the M3 layer 58 are also removed.

FIG. 7B shows the block 52 of FIG. 7A after the abstraction step 80. As a result, a pin 16e is formed in the M3 layer 58. The pin 16e provides a valid site for a top-level router to drop a via from the next higher level in the netlist without violating the via stacking rule.

The above described pin assignment method of the present invention, as set forth in FIG. 2, may be used with any block-based design process in the development of integrated circuits. It can be readily appreciated by those skilled in the art that this method has particular utility for pin assignment in blocks with relatively high pin counts and pin densities.

Furthermore, the present invention may also be used in the block-based architecture as disclosed in U.S. Pat. No. 6,536,028 for Standard Block Architecture for Integrated Circuit Design and U.S. Pat. No. 6,467,074 for Integrated Circuit Architecture with Standard Blocks. In such event, the block 14 may the standard block as described in the herein referenced patents and the components 20 described above may be standard cells.

There has been described above a novel method for assigning pins in to individual blocks used in block-based integrated circuit design methodologies. Those skilled in the art may now make numerous uses of, and departures from, the above described exemplary embodiments without departing from the inventive principles disclosed herein.

Accordingly, the present invention is to be defined solely by the scope of the appended Claims.

1. A method of pin assignment in a block in a block-based integrated circuit design process, the method comprising steps of:
assigning within the block a plurality of block pins to a respective one of a plurality of first locations;
placing in the block a plurality of components wherein each of the components is placed relatively proximal to the pins respectively connecting to each of the components;
moving selected ones of the pins to a respective one of second locations proximal the components connecting to the selected ones of the pins; and
refining placement of the components with respect to the selected ones of the pins at the second location connecting thereto.

2. A method as set forth in claim 1 wherein said assigning step includes the steps of:
locating the first locations proximal a periphery of the block; and
placing the pins in the first locations in accordance with connectivity constraints to other such pins connecting thereto contained in other such blocks at a current hierarchical level of the integrated circuit.

3. A method as set forth in claim 2 wherein said placing step is performed using a heuristic based on a shortest distance of each of the pins in the block to pins in other such blocks to which each of the pin connects.

4. A method as set forth in claim 2 wherein global routing to detect blockages and congestion is used to avoid the blockages and congestion while routing a connection from each of the pins to the pins in the other blocks.

5. A method as set forth in claim 2 wherein said placing step includes the step of selecting from a criticality ranking associated with each of the timing paths a most critical timing path between the block and one other of such blocks such that the pins on the most critical path are first assigned and pins on remaining timing paths assigned in order of decreasing criticality ranking.

6. A method as set forth in claim 2 wherein said placing step includes the step of maintaining parallel alignment of bus pins in the block to corresponding bus pins in one other of the blocks, wherein the bus pins in the block and the one other of the blocks are each abstracted as a single distributed pin.

7. A method as set forth in claim 1 wherein said moving step includes the steps of:
defining a bounding box containing a plurality of component pins of selected ones of the components to which a respective one of the block pins connects; and
distributing each respective one of the block pins into the bounding boxe containing the component pins to which it connects.

8. A method as set forth in claim 7 wherein said distributing step and said refining step are reiteratively performed.

9. A method as set forth in claim 1 wherein said moving step includes the step of abstracting a shape of each of the pins from a small shape to a distributed shape to enhance routability at a top hierarchical level of the integrated circuit.

10. A method as set forth in claim 1 wherein the block has a plurality of metal layers, the pins being in a selected one of the metal layers.

11. A method as set forth in claim 10 wherein the width of the pins is substantially equivalent to a minimum layer width of the selected one of the metal layers.

12. A method as set forth in claim 11 wherein the width of one of the pins is a width of a net to which the one of the pins is contained in the event the width of the net is required to be larger than the minimum layer width.

13. A method as set forth in claim 10 wherein a minimum spacing of the pins is substantially equivalent to a minimum layer spacing rule established for the selected one of the layers.

14. A method as set forth in claim 13 wherein the spacing between two selected ones of the pins is larger than the minimum layer spacing for the selected one of the layers in the event a net containing the two selected ones of the pins requires a larger spacing than the minimum spacing.

15. A method as set forth in claim 10 wherein one of a power net and ground net is interposed the pins of a first signal net and the pins of a second signal net in the event one of the power net and the ground net is interposed the first and second signal net.

16. A method as set forth in claim 1 further comprising the steps of:
defining a virtual pin to a selected location in a temporary top metal layer of the block;
routing between the virtual pin and a further pin in a lower metal layer within the block wherein at least one via is formed between the temporary top layer and a lower metal layer immediately below the temporary layer; and
abstracting the block wherein the top metal layer and the via are removed, one of the pins being assigned in the second metal layer to the selected location immediately below the removed via.

17. A method as set forth in claim 16 wherein the virtual pin is included in a blockage in the top layer, the blockage preventing routing of the temporary layer within the block.

18. A method of pin assignment in a plurality of blocks in a netlist, the method comprising steps of:
assigning within each of the blocks a plurality of block pins to a respective one of a plurality of first locations;
placing in each of the blocks a plurality of components wherein each of the components is placed relatively proximal to the pins respectively connecting to each of the components;
moving selected ones of the pins to a respective one of second locations proximal the components connecting to the selected ones of the pins; and
refining placement of the components with respect to the selected ones of the pins at the second location connecting thereto.

19. A method as set forth in claim 18 wherein said assigning step includes the steps of:
locating the first locations proximal a periphery of each of the blocks; and
placing the pins in the first locations in one of the blocks in accordance with connectivity constraints to the pins connecting thereto contained in other such blocks at a current hierarchical level of the netlist.

20. A method a set forth in claim 19 wherein said placing step is performed using a heuristic based on a shortest distance of each of the pins in one of the blocks to pins in other ones of the blocks to which each of the pin connects.

21. A method as set forth in claim 19 wherein global routing to detect blockages and congestion is used to avoid the blockages and congestion while routing a connection from each of the pins to the pins in the other ones of blocks.

22. A method as set forth in claim 19 wherein said placing step includes the step of selecting from a criticality ranking associated with each of the timing paths a most critical timing path between the block and one other of the blocks such that the pins on the most critical path are first assigned and pins on remaining timing paths assigned in order of decreasing criticality ranking.

23. A method as set forth in claim 19 wherein said placing step includes the step of maintaining parallel alignment of bus pins in one of the blocks to corresponding bus pins in one other of the blocks, wherein the bus pins in the one of the blocks and the one other of the blocks are each abstracted as a single distributed pin.

24. A method as set forth in claim 18 wherein said moving step includes the steps of:
defining a plurality of bounding boxes wherein each one of the bounding boxes contains a plurality of component pins of selected ones of the components to which a respective one of the block pins connects; and
distributing each respective one of the block pins into the one of the bounding boxes containing the component pins to which it connects.

25. A method as set forth in claim 24 wherein said distributing step and said refining step are reiteratively performed.

26. A method as set forth in claim 18 wherein said moving step includes the step of abstracting a shape of each of the pins from a small shape to a distributed shape to enhance routability at a top hierarchical level of the integrated circuit.

27. A method as set forth in claim 18 wherein each of the blocks has a plurality of metal layers, the pins being in a selected one of the metal layers.

28. A method as set forth in claim 27 wherein the width of the pins is substantially equivalent to minimum layer width of the selected one of the metal layers.

29. A method as set forth in claim 28 wherein the width of each one of the pins is a width of a net to which each one of the pins is contained in the event the width of the net is required to be larger than the minimum layer width.

30. A method as set forth in claim 27 wherein a minimum spacing of the pins is substantially equivalent to a minimum layer spacing established for the selected one of the layers.

31. A method as set forth in claim 30 wherein the spacing between two selected ones of the pins is larger than the minimum layer spacing for the selected one of the layers in the event a net containing the two selected ones of the pins requires a larger spacing than the minimum layer spacing.

32. A method as set forth in claim 27 wherein one of a power net and ground net is interposed the pins of a first signal net and the pins of a second signal net in the event one of the power net and the ground net is interposed the first and second signal net.

33. A method as set forth in claim 18 further comprising the steps of:
defining a virtual pin to a selected location in a temporary top metal layer of one of the blocks;
routing between the virtual pin and a further pin in a lower metal layer within the one of blocks wherein at least one via is formed between the temporary top layer and a lower metal layer immediately below the temporary layer; and
abstracting the one of blocks wherein the top metal layer and the via are removed, one of the pins being assigned in the second metal layer to the selected location immediately below the removed via.

34. A method as set forth in claim 33 wherein the virtual pin is included in a blockage in the top layer, the blockage preventing routing of the temporary layer within the block.

35. A method as set forth in claim 18 wherein the assigning, placing, moving and refining steps are performed on each of the blocks sequentially with respect to each other of the blocks at the current hierarchical level in the netlist.
